(19) United States
(12) Patent Application Publication
(10) Pub. No.: US 2006/0092146 A1
(43) Pub. Date: May 4, 2006

(54) Organic led display device and method for driving usch a device

(75) Inventors: Mark Thomas Johnson, Veldhoven (NL); Johannes Nicolaas Huiberts, Eindhoven (NL); Peter Van De Weijer, Heeze (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/536,845

(22) PCT Filed: Nov. 25, 2003
(86) PCT No.: PCT/IB03/05432

§ 371 Date: May 31, 2005

(30) Foreign Application Priority Data
Dec. 4, 2002 (EP) 021026802

(51) Int. Cl. G09G 5/00

(52) U.S. Cl. 345/204

(57) ABSTRACT

A method for driving an organic LED display device having a first and a second electrode sandwiching an organic layer defining a plurality of light emitting elements. The method comprises applying to a light emitting element a voltage within a specified voltage range, within which the risk of short circuits between the electrodes is reduced, and controlling the duty cycle of said light emitting element, so that a desired light intensity is emitted from said light emitting element. The probability of short circuits in pixels of an organic LED display device is thus reduced by avoiding operating the display pixels within voltage ranges where the chance of short circuits is high. This limitation of the applied voltage is compensated by controlling the duty cycle of the light emitting element.

The present invention relates to a method for driving an organic LED display device, having a first and a second electrode sandwiching an organic layer, e.g. a polymer (PLED) or a small organic molecule (OLED) layer.

Short circuits in organic displays are particularly serious as they directly lead to pixel failures. In an organic LED device an organic layer provides an electrical insulation in between the two electrodes, and during operation this layer is subject to high electric fields. At the same time, local disturbance of the organic layer (particle, pin hole etc.) occur, and a local leakage current is created as a result of direct contact between the electrodes due to these disturbances.

The development of a short circuit is driven by the electrical energy dissipated by the local leakage current. The energy dissipation increases during the lifetime of the display, due to a voltage increase necessary to sustain a constant device current. Such a voltage increase with lifetime is very characteristic of organic LED displays, where constant device current is the preferred way of driving.

When the energy dissipation leads to a local temperature higher than a decomposition temperature (including melt and even boiling points of materials present), local damage occurs. Typically the result of such damage is twofold. It can give rise to an even higher local leakage current and consequently new damage will arise. The layers act as a “fuse”, being unable to sustain this high leakage current. On the other hand the damage can lead to a decrease of the leakage current and therefore a decrease of the local temperature. The defect is neutralized until an increase of the applied voltage again leads to new damage.

An object of the present invention is to reduce the risk for short circuits in organic LED displays.

This and other objects are achieved by applying to a light emitting element a voltage within a specified voltage range, within which the risk of short circuits between the electrodes is reduced, and controlling the duty cycle of said light emitting element so that a desired light intensity is emitted from said light emitting element.

According to the invention, the probability of short circuits in pixels of an organic LED display device is thus reduced by avoiding operating the display pixels within voltage ranges where the chance of short circuits is high. This limitation of the applied voltage is compensated by controlling the duty cycle of the light emitting element. Duty cycle control of organic LEDs is known per se, see e.g. U.S. Pat. No. 6,023,259.

The invention relies upon the realization that the perceived brightness of a pixel in a display is a function of its brightness during emission and the ratio of time that each pixel emits light (its “duty cycle”). It is therefore theoretically possible to generate a pixel of any perceived brightness from a pixel with any given actual brightness providing that the duty cycle is continuously variable. This realization allows us therefore to choose the actual operating voltage of any given pixel, by controlling the duty cycle accordingly.

Research shows that there typically exists a certain voltage range, limited both above and below, within which the risk of shorts is reduced. By controlling the duty cycle of the light emitting elements in the display, the voltage can be kept within such a range, without limiting the range of emitted light intensity.

In some situations, for example where dark images are displayed, the applied voltage is sometimes below a critical value, whereby the risk for short circuits increases considerably. In such a case, the operating voltage of the pixels can be controlled to remain above the critical value by reducing the duty cycle of the pixel.

In other applications, a duty cycle smaller than 100% is chosen as the default operation method. One example is active matrix PLED/OLED displays for video applications (TV's, DVD players etc.), where the duty cycle is reduced to reduce motion blur artifacts (the so called “sample-hold” artifact). Another, more general example is to reduce the duty cycle to increase the brightness uniformity across an active matrix display (reduces the effects of transistor to transistor variation in the poly-Si TFTs on uniformity).

In such situations, the choice of a too small duty cycle, whilst beneficial to the display performance, may cause certain pixels within the display (for example one type of colored pixel) to operate at voltages above a critical value, whereby the risk of short circuits increases considerably. In this case, the operating voltage of the pixels can be controlled to remain below the critical value by increasing the duty cycle of the pixel (even if this slightly reduces the performance of the display).

Choosing a default duty cycle less than 100% also allows for a gradual increase of the duty cycle over time. This may be advantageous, as the applied voltage often changes, and in particular increases during the lifetime of an organic display. If the rate of voltage increase is known (or can be derived from look-up tables or analytical functions), instead the duty cycle can be increased accordingly, thereby enabling the operation voltage to remain below any critical value for shorts formation.

According to one embodiment, this can be done by monitoring the average voltage of pixels within the display, for example by monitoring the power dissipation of the display. In this case, the actual (average) voltage will be monitored, and the duty cycle adjusted as required.

According to a further embodiment, the voltage of individual, or representative, pixels in the display is monitored, whereby the duty cycle of each pixel need only be increased when the critical voltage is actually reached. This ensures that the display is always operating at its highest possible performance level without increasing the risk of short circuit formation.

The duty cycle can be controlled over each frame (a single frame duty cycle), or over several frames (a multi frame duty cycle). The latter alternative may be implemented in passive as well as active matrix display devices.

In an active matrix display, the duty cycle may be controlled for each light emitting element individually, or for several element (e.g. all elements) jointly.

The former implementation allows optimal adjustment possibilities, while the latter is less complex and more cost efficient to implement.

These and other aspects of the invention will be apparent from the preferred embodiments more clearly described with reference to the appended drawings.

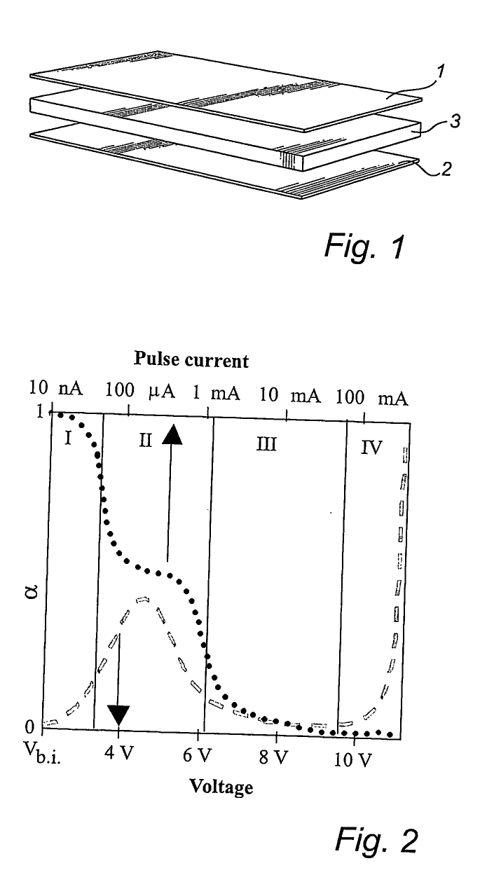

FIG. 1 is a schematic perspective view of a pixel in an organic LED display.

FIG. 2 is a diagram illustrating four voltage regimes of the display in FIG. 1.

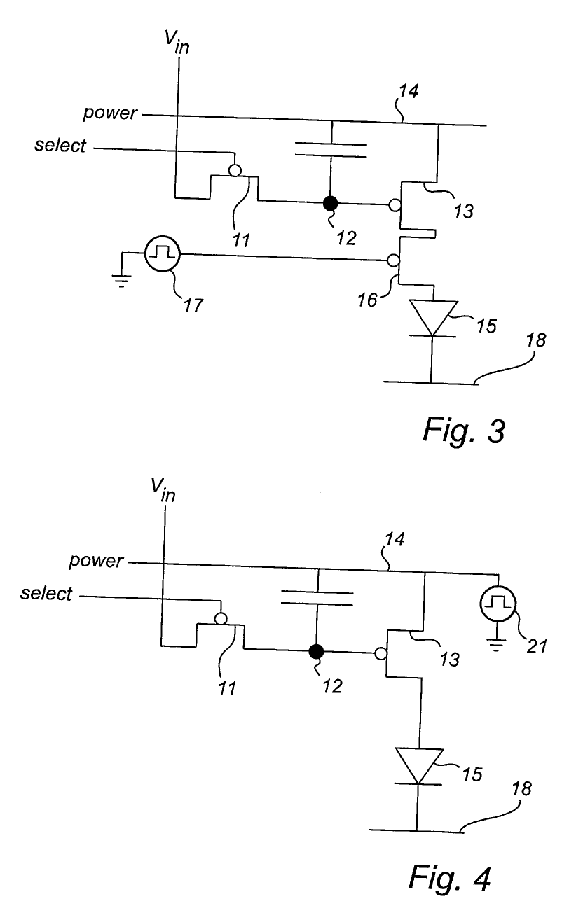

FIG. 3 is a schematic circuit diagram of a pixel drive according to a first embodiment of the invention.

FIG. 4 is a schematic circuit diagram of a pixel drive according to a second embodiment of the invention.

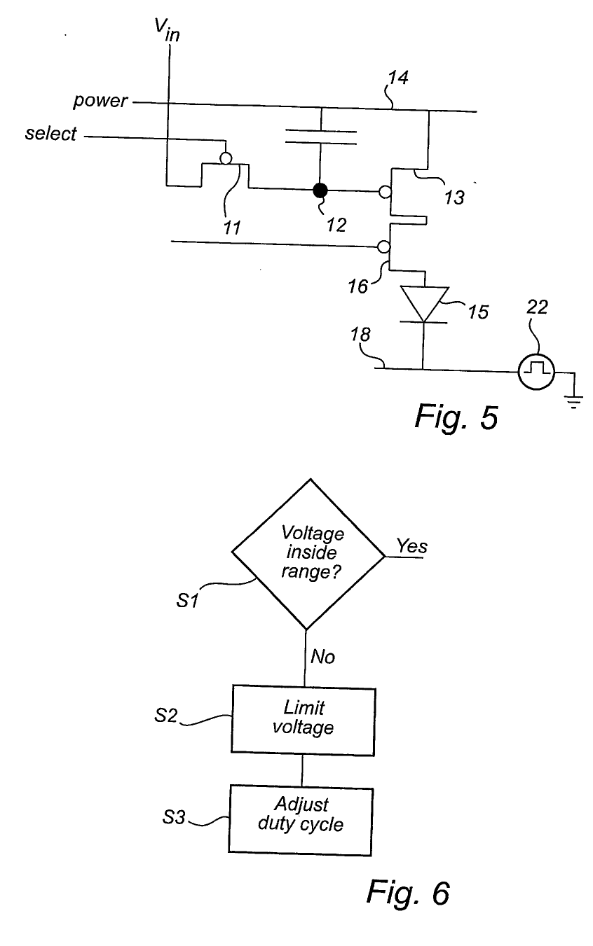

FIG. 5 is a schematic circuit diagram of a pixel drive according to a third embodiment of the invention.

As mentioned above, the invention is based on controlling the voltage of the light emitting elements in the display, so that they are kept within a specified voltage range which reduces the risk for shorts. In the following, it will be discussed more in detail how such a range is specified. Reference is made to FIG. 1, showing a pixel in an organic display device with a top and a bottom electrode 1, 2, and an intermediate organic (polymer (PPV) or small organic molecule) layer 3.

The electrostatic attractive force between the top and bottom electrodes 1, 2 provokes physical contact after initial damage of the organic layer 3. This force is directly related to the applied voltage (typically 50-100 MV/m) and the thickness of the organic layer 3 (typically 60-120 nm for a PLED device). As this layer thickness is essentially constant, the voltage plays an important role in the evolution of short circuits.

Further, damage due to a local discharge is found to be more extensive when the adhesion between the constituting layers is poor. The electrostatic force caused by the applied voltage leads to an artificial improvement of the adhesion, as the layers are squeezed together. Again a correlation between voltage (electrostatic force) and shorts probability is identified.

Apart from the voltage, also the device current or more specifically the segment current plays an important role. Typically a short circuit is a local phenomenon (typically 1-10 μm) much smaller than a pixel. A short circuit is nothing more than a sustained stable or unstable high leakage current, of the order of the segment current. Feeding a constant current to a segment with a short circuit will therefore result in the loss of light, be it stable or unstable (flickering).

However, there is a limit as to how high a leakage current the LED layers can sustain, thus limiting the maximum current that can flow through a leakage channel (this phenomenon will be referred to as “fusing”). Consequently, with respect to possible short circuits, it is preferable to have a shorter, higher current pulse instead of a DC current to emit a certain amount of light. The influence of the short circuit is small when the ratio of the pulse current to the maximum leakage current in the pixel:

$${R}_{OLED}^{DRIVING} = \frac{{I}_{dev}^{pulse}}{{I}_{leakage}^{MAX}} \qquad ( 1 )$$

is high.

Experimental evidence further shows that the development of initial local damage into a short circuit depends on the device current as well as the voltage used.

This can be expressed:
Pₛₕₒᵣₜ=αA_{dev}, (2)
where α is the proportionality constant between the shorts probability (Pₛₕₒᵣₜ) and the device area (A_{dev}).

In FIG. 2, four different regimes I-IV can be distinguished in the interrelation between the applied voltage (dashed line, 11) and the shorts probability, and between the pulse current (dotted line, 12) and the shorts probability, respectively. The boundaries 13 (shaded areas) between the different regimes vary for different polymers and depend also on the exact layer composition.

Based on measurements and the model sketched above, the four regimes can be characterized as follows.

I) At small values for the voltage, instabilities in the leakage current are experimentally found to be small. The electrostatic attractive force is still too small to provoke direct contacts. This relates directly to the elastic properties of the constituting layers. Furthermore the dissipated energy (˜Vₐₚₚₗ/R_{channel}, where Vₐₚₚₗ is the applied voltage and R_{channel} is the resistance of the local leakage path) is too small to cause damage.

II) In this voltage regime the “fusing” results in strong current instabilities.

The electrostatic force brought about by the voltage squeezes the cathode against the anode. However, the consequential damage leads to new contacts and therefore damage etc., and the short circuit expands. Also, the short circuit probability typically increases with the perimeter of the damaged region (leakage channel), and as the increase of damage occurring in this voltage regime leads to an increase of this perimeter, the shorts probability increases as well.

III) At voltages between 5 and 10 Volt again a strong decrease of the short circuit probability is observed. The instabilities disappear above a certain voltage (V_{FUSE}) and the leakage current decreases. The artificial increase of the adhesion between the layers discussed above favors the healing probability (increase of the R_{channel} upon damage). This third regime is the preferred regime for LED driving.

IV) It has been experimentally observed that for voltages above a certain threshold value (˜10 Volt for a typical 70 nm thick organic devices) all devices tend to a situation where the leakage current is exceptionally high. The result is short circuits. Apparently the local temperature (directly related to the dissipated power, ˜Vₐₚₚₗ/R_{channel}) reaches such high values that one of the electrodes decomposes as well, or that the adhesion between the layers is broken in some other way (e.g. gas formation). Experimentally it has also been found that this effect starts very suddenly as a function of voltage. The threshold voltage (Vₜₕ) is found to vary as a function of the polymer type and device composition.

As a conclusion we should state that in general for the applied voltage the following condition should be fulfilled:
V_{FUSE}<Vₐₚₚₗ<Vₜₕ (3)
whereby the condition on the device current ratio mentioned in eq. 1,

$${R}_{OLED}^{DRIVING} >> 1 ,$$

required to achieve a low short circuit probability, should be fulfilled.

An embodiment of the method according to the invention is illustrated in FIG. 6. First, in step S1, it is established whether the voltage applied to the light emitting element is inside the specified range (eq. 3). If this is not the case, then the voltage will be limited in step S2, and the duty cycle will be adjusted accordingly in step S3.

With reference to FIGS. 3-5, the above conditions are applied to the driving scheme of an active matrix polymer LED device. The above objectives can be achieved in an active matrix application, as the duty cycle of the pixels (light emitting elements) in such displays can be chosen freely. The reason is that it is possible to set the brightness level of the pixel (addressing) without the pixel actually emitting light.

FIG. 3 shows an active matrix circuit suitable for driving an organic light emitting element 15, e.g. a PLED or an OLED, according to the invention. The circuit has an addressing transistor 11 that allows writing of the data voltage (Vᵢₙ) into a store point 12. This voltage determines the gate voltage of a drive transistor 13 with respect to a power line 14. If the gate voltage is larger than the threshold voltage of the drive transistor 13, a current flows from the power line 14 to a cathode 18, via the PLED/OLED 15, provided there between. The PLED/OLED 15 then generates light.

The circuit in FIG. 3 further comprises an additional transistor 16, connected between the PLED/OLED 15 and the drive transistor 13. This transistor defines the duty cycle of the OLED/PLED. The pixel can only emit light when this transistor is made conducting. In this embodiment, the duty cycle can be modified by defining the period that the additional transistor 16 is in a conducting state. The gate of the transistor 16 is connected to circuitry 17 for controlling the duty cycle, i.e. the period of a frame that the transistor 16 is open. The circuitry 17 can be e.g. a pulse width modulator.

If all of the duty cycle transistors 16 in a display are connected to a single controller 17, it will be possible to modify the duty cycle of all pixels in the entire display jointly, to ensure safe pixel voltages. According to a preferred embodiment, portions of the display can have their duty cycles individually set and modified by providing individually addressed duty cycle transistors 16 (for example one set for each colored pixel).

Turning now to FIG. 4, this illustrates a second embodiment of a pixel circuit suitable to realize the invention. Elements similar to the elements in FIG. 3 have been given identical reference numbers. According to this embodiment, the power line 14 is provided with circuitry 21, similar to the circuitry 17 in FIG. 3, to enable adjustment of a period of a frame that the power line is set to high voltage. This “power line duty cycle” in turn defines the duty cycle of the PLED/OLED pixel, as the pixel can only emit light when the power supply is set to high voltage. According to this embodiment, the duty cycle can thus be modified by adjusting the period of a frame that the power line is turned to high voltage.

If all pixels are connected to a single power line 14, it will be possible to modify the duty cycle of the entire display to ensure safe pixel voltages. According to a preferred embodiment, portions of the display will be able to have their duty cycles individually set and modified by providing multiple power lines (for example one power line for each set of colored pixels).

A third embodiment of a pixel circuit for realizing the invention is illustrated in FIG. 5, where again elements similar to the elements in FIG. 3 have been given identical reference numbers. Circuitry 22, similar to the circuitry 17 in FIG. 3, is connected to the cathode 18 of the PLED/OLED 15. Through this arrangement, the pixel duty cycle can be modified by adjusting the voltage on the PLED/OLED cathode 18. If the cathode voltage is set high (in general higher than the power line voltage) the pixel cannot emit light, as the diode is set into reverse voltage. According to this embodiment, the duty cycle can therefore be modified by adjusting the period of the frame that the cathode is set to low voltage.

In general for active matrix PLED/OLED displays all pixels are connected to a single cathode connection, and it will be possible to modify the duty cycle of the entire display to maintain safe pixel voltages. It is also possible to provide multiple cathodes (for example one cathode for each set of colored pixels), and thereby enable different portions of the display to have their duty cycles individually set and modified.

Whilst in the FIGS. 3-5 the most simple voltage addressed active matrix PLED/OLED pixel circuit has been illustrated as an example, it is possible to apply similar measures to a large number of both voltage and current addressed pixel circuits known in the art. In addition, other method, as known from the prior art, to generate duty cycles in organic LED displays may also be advantageously be applied, for example methods whereby the pixels in the display are addressed more than once in each frame and where the pixel can be addressed to generate light in a first sub-frame period, and addressed not to generate light in a subsequent sub-frame period.

In the above embodiments, the expression “duty cycle” has been used only relating to one frame at a time. However, the invention is not limited to this interpretation, and a further preferred embodiment includes the implementation of a “duty cycle” over several frames, i.e. controlling selected pixels to be unlit during selected frames, in order to reduce the aggregated emitted light intensity.

This may be advantageous in e.g. situations where it is, in practice, unreasonable to further reduce a frame duty cycle, for example where electronics requires at least a certain time to stabilize its operation. In such situations, in order to reach the desired perceived brightness level, some of the less bright pixels may require a voltage which is below one of the critical values described above. This will increase the risk of short circuits in these pixels.

In such situations, the display can be driven in a manner that such pixels are no longer addressed every frame. For example, by addressing these pixels every two frames, a pulse of two times higher brightness will be required in the frame when the pixel is active to achieve the same perceived brightness. In this manner, the pixel will operate at a higher voltage—above the critical value—during the active frame, and the risk of shorts will again decrease. In the other, inactive frame, the pixel is not driven at all, and will not short circuit.

Of course, if a still further increase in operating voltage is required, the pixel may be addressed even less frequently. If only a small decrease is required, the pixel may be addresses e.g. two out of three frames.

In order to operate the display in this manner, a small amount of data processing will be required to identify pixels which require such multiple frame driving and adjust the driving signals accordingly.

It should be noted that this embodiment of the invention is not limited to active matrix displays, but may advantageously be used also in passive matrix displays, to again avoid less bright pixels operating at too low voltages. This is more likely to be relevant when the passive matrix generates grey levels using amplitude modulation driving. Implementation can be similar to that described above for active matrix applications.

1. A method for driving an organic LED display device having a first and a second electrode (1, 2) sandwiching an organic layer (3) defining a plurality of light emitting elements (15), said method comprising: applying (S1, S2) to a light emitting element (15) a voltage within a specified voltage range, within which the risk of short circuits between the electrodes (1, 2) is reduced, and controlling (S3) the duty cycle of said light emitting element (15), so that a desired light intensity is emitted from said light emitting element (15).

2. A method according to claim 1, wherein the duty cycle of said light emitting element is decreased in order to emit a desired light intensity without requiring an applied voltage below a specified lower limit.

3. A method according to claim 1, wherein a default duty cycle of said light emitting element is less than 100%, and wherein said duty cycle is increased in order to emit a desired light intensity without requiring an applied voltage above a specified upper limit.

4. A method according to claims 2 or 3, further comprising: determining an expected voltage change over time, required to maintain a constant drive current in said light emitting element, and adjusting the duty cycle of said light emitting element accordingly.

5. A method according to claims 2 or 3, further comprising: monitoring an average pixel voltage in the display, and adjusting the duty cycle of each light emitting element in accordance with this average voltage.

6. A method according to claims 2 or 3, further comprising: monitoring a voltage of a light emitting element, and adjusting the duty cycle of said light emitting element in accordance with this voltage.

7. A method according to any one of the preceding claims, wherein said duty cycle is controlled over each frame.

8. A method according to claim 1-6, wherein the duty cycle is controlled over a plurality of frames.

9. A method according to any one of the preceding claims, wherein said display device is of active matrix type.

10. A method according to claim 9, wherein the duty cycle is controlled for each light emitting element individually.

11. A method according to claim 9, wherein the duty cycle is controlled for a plurality of light emitting elements jointly.

12. A method according to claim 8, wherein the display device is of passive matrix type.

13. An organic display device, arranged to be driven according to one of the preceding claims.

14. An organic display device having a first and a second electrode (1, 2) sandwiching an organic layer (3) defining a plurality of light emitting elements (15), further comprising: means (13, 14) for applying a voltage to a light emitting element (15), said voltage lying in a specified voltage range within which the risk of short circuits between the electrodes (1, 2) is reduced, and means (16, 17; 21; 22) for controlling the duty cycle of said light emitting element (15), so that a desired light intensity is emitted from said light emitting element (15).

15. A device according to claim 14, wherein said controlling means (16, 17; 21; 22) are arranged to decrease the duty cycle in order to emit a desired light intensity without requiring an applied voltage below a specified lower limit.

16. A device according to claim 14, wherein said controlling means (16, 17; 21; 22) are arranged to maintain a default duty cycle of said light emitting element less than 100%, and to increase the duty cycle in order to emit a desired light intensity without requiring an applied voltage above a specified upper limit.

17. A device according to one of claims 14-16, wherein said controlling means comprises a transistor (16), connected between the light emitting element (15 and the voltage applying means (13, 14), and a duty cycle controller (17), connected to the gate of the transistor (16).

18. A device according to one of claims 14-16, wherein said controlling means comprises a duty cycle controller (21) connected to the voltage applying means (14).

19. A device according to one of claims 14-16, wherein said controlling means comprises a duty cycle controller (22) connected to the other side of the light emitting element (15) in relation to the voltage applying means (13, 14).

20. A device according to any one of claims 14-19, wherein said voltage applying means comprises a power line (14) and a drive transistor (13) connected between the power line and the light emitting element (15).

21. A device according to any one of claims 14-20, wherein said controlling means (16, 17; 21; 22) are arranged to jointly control the duty cycle for a plurality of light emitting elements.
